(19) United States
(12) Patent Application Publication
(10) Pub. No.: US 2008/0120567 A1
(43) Pub. Date: May 22, 2008

(54) COOPERATIVE BLADE FRONT PANELS

(75) Inventor: Christopher K. Karstens, Apex, NC (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/561,029

(22) Filed: Nov. 17, 2006

(51) Int. Cl. G06F 3/048

(52) U.S. Cl. 715/772

(57) ABSTRACT

A computer program product and method for providing a central server having a plurality of displays with consistent displays of graphical content are presented and calls for inputting preferences; polling baseboard management controllers; and formulating the consistent displays of graphical content to provide the consistent displays of graphical content.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to displaying indicators in a central server.

2. Description of the Related Art

A central server may include many resources with displays such as blade servers. Each blade server may have a display, including a touchscreen display, providing various indications. The indications may include graphical content (such as icons) for a power indicator, an activity status, and a trouble indicator. The symbols, colors, sizes, and locations of the graphical content for the same functions may be different for each blade server.

On one blade server a lightening bolt indicates “activity” while on another blade server a three dimensional cylinder indicates activity. As another example, on one blade server the power indicator graphical content is 0.25 inches high on the upper left part of the display while on another blade server the power indicator graphical content is 0.75 inches high on the bottom right.

Blade servers of different generations may have a differing number of functions to display. For example, an older generation blade server may have four functions to display while a newer generation blade server may display six functions. Touchscreens have similar display problems as described below.

Touchscreens besides having a display function also have an input function. An operator can touch graphical content on the touchscreen corresponding to a function. The function will be input to the device with the touchscreen. For example, touching the graphical content corresponding to a power-on button on the blade server will turn the power on to the blade server. An operator may be accustomed to consistently touching a specific part of the touchscreen (for example, the upper left) to perform a certain function. If the operator has to perform the same function on a different blade server with a different graphical content arrangement (for example, the lower right), he or she may inadvertently perform a non-intended function. As one skilled in the art knows, performing incorrect functions on blade servers may lead to costly downtime and delays.

What are needed are software and hardware to display the graphical content on displays and touchscreens in a consistent manner.

### SUMMARY OF THE INVENTION

The shortcomings of the prior art are overcome and additional advantages are provided through the provision of a computer program product stored on machine-readable media including machine-readable instructions for providing a central server having a plurality of displays with consistent displays of graphical content, the instructions for implementing a method include inputting preferences; polling baseboard management controllers; and formulating the consistent displays of graphical content to provide the consistent displays of graphical content.

Also disclosed is a central server system having a plurality of displays including a computer program product having instructions for providing consistent displays of graphical content, the product includes instructions for inputting preferences; inputting the preferences manually; inputting the preferences automatically; inputting default preferences; inputting the preferences based upon a selected version of the baseboard management controller; inputting preferences that impose one display of graphical content for each instance of a function; inputting preferences that use custom graphics for symbols; mapping functions of push buttons; polling baseboard management controllers; formulating the consistent display of graphical content; and implementing the consistent display of graphical content via the baseboard management controllers to provide the consistent display of graphical content.

### TECHNICAL EFFECTS

As a result of the summarized invention, technically we have achieved a solution in which a computer program product stored on machine-readable media includes machine-readable instructions for providing a central server having a plurality of displays with consistent displays of graphical content, the instructions for implementing a method include inputting preferences; polling baseboard management controllers; and formulating the consistent displays of graphical content to provide the consistent displays of graphical content.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a central server for implementation of the teachings herein;

FIG. 2 depicts aspects of a prior art display;

FIG. 3 depicts aspects of a blade server display with a consistent display of graphical content; and

FIG. 4 illustrates an exemplary method for implementing consistent displays of graphical content.

The detailed description explains the preferred embodiments of the invention, together with advantages and features, by way of example with reference to the drawings.

### DETAILED DESCRIPTION OF THE INVENTION

The teachings provide for displaying graphical content on displays of a plurality of blade servers installed within a central server. As is known in the art, the central server provides an infrastructure for operation of each blade server. Each blade server includes a display. The display of each blade server provides graphical content for indicating at least one function of the blade server. The displaying disclosed herein provides for consistent and uniform appearance of graphical content for each of the blade servers with respect to another blade server. Typically, consistent displays provide the same graphical content for each instance of a function. The teachings discuss displays in general terms. One skilled in the art will recognize that the teachings also apply to other forms such as touchscreen displays. The teachings include three parts. A first part calls for receiving input for user preferences for providing the consistent displays. A second part calls for determining the existing graphical content and patterns for the displays. A third part calls for formulating consistent displays. Prior to discussing the various parts, certain definitions are provided.

As used herein, use of the term “display” is typically with regard to displays provided on each blade server. The displays, however, may also be part of other components of the central server. As one skilled in the art will understand, the display is often one of a LCD display and OLED display and may include touchscreen capabilities. The exemplary embodiments disclosed herein are in general with reference to these displays. Also as used herein, the term “graphical content” relates to a graphic display indicator for providing an indication regarding a component (e.g., a particular blade server). Generally speaking, each display of graphical content provides an indication of at least one of a status, a purpose and another aspect of the component. The graphical content includes graphics, icons, animations, and text. The term “pattern” relates to an order of locations of graphical content.

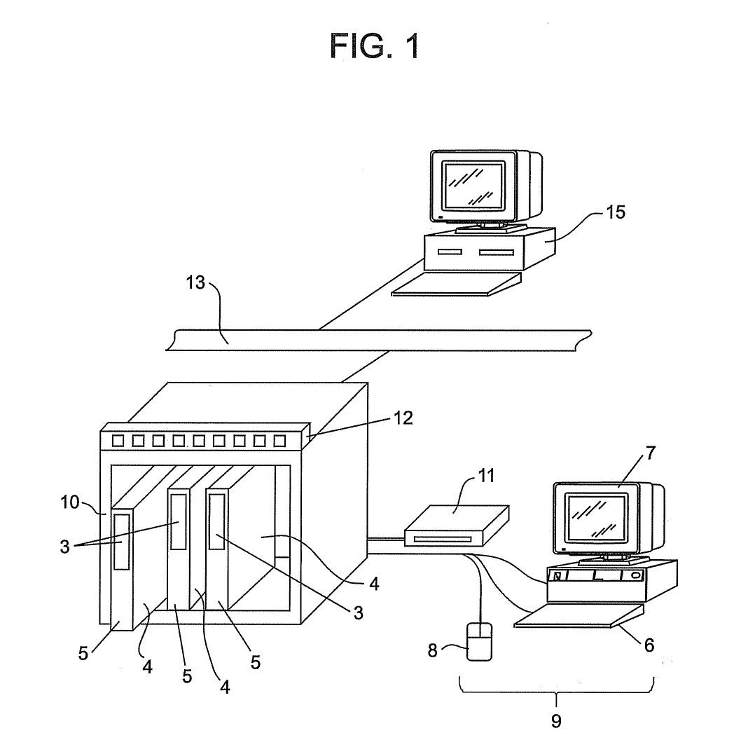

Referring to FIG. 1, there is shown an embodiment of a central server referred to as a blade chassis 10. In one embodiment, a plurality of blade servers 5 (or blade server 5) fit in the blade chassis 10 like books in a bookshelf. Typically, each of the blade servers 5 is an independent server 10, with its own processors, memory, storage, network controllers, operating system and applications (not shown). Each blade server 5 slides into a bay in the blade chassis 10 and plugs into a mid-plane or backplane of the blade chassis 10. The plurality of blade servers 5 are thus provided with shared power, fans, floppy drives, switches, ports and other supporting resources. In typical embodiments, each blade server 5 is of a compact design, and “hot-swappable” (meaning designed for automatic installation and operation when inserted into the blade chassis 10 at power, and likewise removable at power).

Many critical components of the blade chassis 10 can be made redundant or hot-swappable, including cooling systems, power supplies, Ethernet controllers and switches, mid-planes and backplanes, hard disk drives and service processors. In short, the blade chassis 10 and the blade servers 5 therein provide resources for storing and executing software (machine-readable instructions). The software may be provided as an “add-in” application (where “add-in” is taken to mean supplemental program code as is known in the art). In such embodiments, the software replaces or supplements structures of the application for providing displays on the blade servers 5.

The benefits of using the blade chassis 10 are known to anyone tasked with running down hundreds of cables strung through racks just to add and remove resources. With switches and power units shared, precious space is freed up. This means that blade servers 5 enable higher density of computing resources with far greater ease.

In blade technology, new servers are deployed by sliding the blade servers 5 in and out of the blade chassis 10. Each blade server 5 connects to infrastructure components coupled to the blade chassis 10. Therefore, most designs for blade servers 5 do not require plugging of multiple cables for installation. Exemplary infrastructure components include a keyboard 6, a video display 7, a mouse 8, and a network 13. Collectively, the keyboard 6, video display 7 and mouse 8 are referred to as a KVM 9. Other components include a compact disc drive, an optical drive, a floppy drive, a flash drive, and other types of drives, which are collectively referred to as the “media tray 11.” Media that may be input to the media tray 11 include a compact disc, optical media, a floppy disc, and flash media. Machine-readable media may also include the network 13.

In advanced blade server systems, machine-readable and executable instructions deployed as software provide additional aspects of functionality. For example, when one slides the blade server 5 into a bay of the blade chassis 10, the software automatically loads a designated operating system and application image into the blade server 5. This provides for getting the newly installed blade server 5 up and running with no human intervention. The software typically provides for repurposing of each blade server 5 as necessary, replacing a failing blade server 5 or applying spare blade servers 5 to help handle peak loads and may perform other functions as desired by system designers, managers or users.

In one embodiment, with reference to FIG. 1, aspects of the blade chassis 10 are monitored and managed from a single location. For example, the blade chassis 10 can be managed from a console 15 used to manage other components in a computing infrastructure. In some embodiments, the blade chassis 10 is managed through an easy-to-use graphical interface that allows remote connection from any terminal connected to the respective network 13. In typical embodiments, a management module 12 is included with the blade chassis 10. The management module 12 is like a computer processing system. The management module 12 typically includes software, firmware, and hardware (such as processors, storage and memory) for, among other things, communication with the various blade servers 5 and a network 13 connecting the blade chassis 10 and other resources. Typically, the console 15 includes an interface with the management module 12.

As shown in FIG. 1, each of the blade servers 5 may include a display 3. The display 3 displays graphical content corresponding to activities related to the blade server 5. The teachings herein relate to the graphical content displayed on the display 3. Each of the blade servers 5 may also include a baseboard management controller (BMC) 4. The BMC 4 manages the interface between the blade server 10 and the management module 12. The BMC 4 provides mapping instructions for aspects of graphical content such as symbols, sizes, colors and locations for the graphical content presented on the display 3.

The teachings herein provide for communication of information between each baseboard management controller 4 and the management module 12. The information may include, without limitation, aspects regarding the BMC 4 and the graphical content displayed on the display 3. The aspects may include, for example, a version and date of the BMC 4. The aspects may also include the symbol, size, color and location for each display of graphical content on the display 3. The teachings provide for communicating instructions from the management module 12 to each BMC 4 regarding the aspects for the graphical content to be displayed.

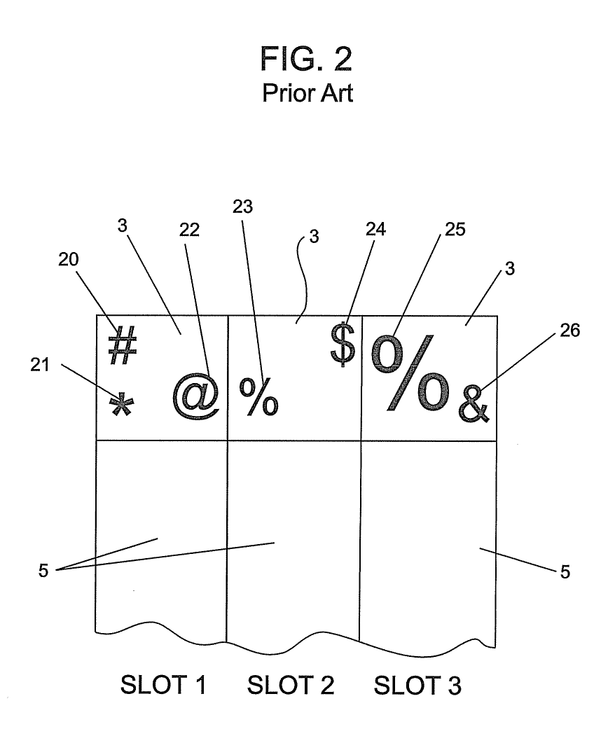

FIG. 2 illustrates a prior art display of graphical content on the displays 3. Each of the three blade servers 5 occupies one slot in the blade chassis 10. The display 3 with the blade server 5 in slot one displays three indicators. Power indication is represented by a power indicator graphical content 20 for slot one that is a “#” symbol and may be blue in color. The activity is represented by an activity graphical content 21 for slot one that is an “*” symbol and may be red in color. Warning indication is provided by a warning graphical content 22 for slot one that is an “@” symbol and may be yellow in color.

The display 3 with the blade server 5 in slot two displays only two indicators. The power indication is represented by a power indicator graphical content 24 for slot two that is a “$” symbol and may be pink in color. The power button is represented by a power button graphical content 23 for slot two that is a “%” symbol and may be orange in color.

The display 3 with the blade server 5 in slot three also displays two indicators. The power button is represented by a power button graphical content 25 for slot three that is the “%” symbol and may be orange in color. The power button graphical content 25 for slot three is larger in size than the power button graphical content 23 for slot two even though it may be the same symbol and the same color. The power indication is represented by a power indicator graphical content 26 for slot three that is an “&” symbol and may be green in color. All of the displays of graphical content in FIG. 2 are different in some way.

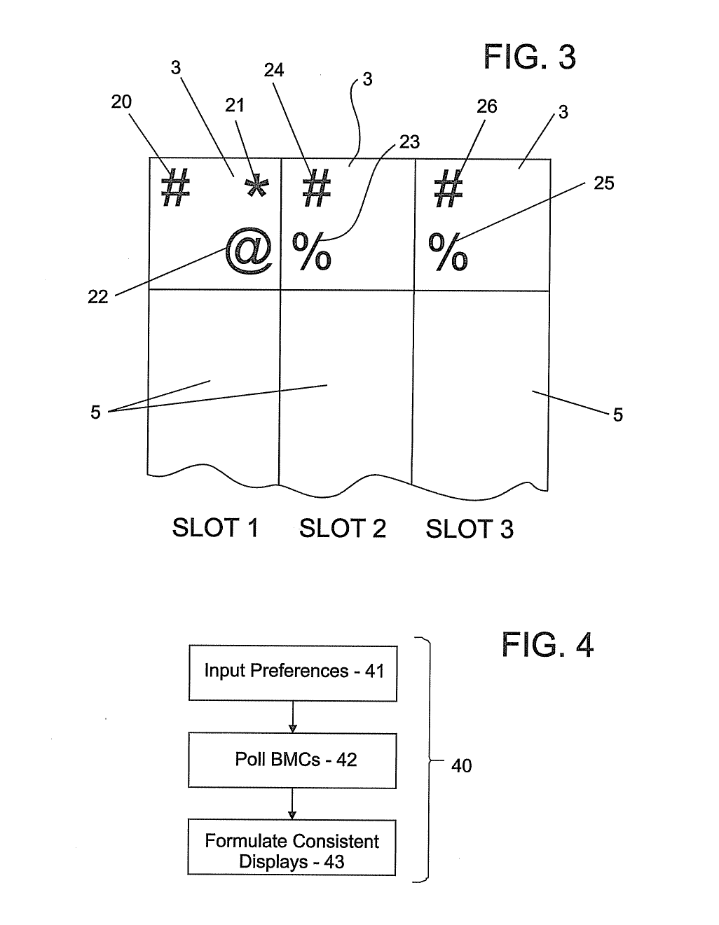

Using the teachings herein, FIG. 3 presents the display functions of FIG. 2 in consistent displays of graphical content. To determine the consistent displays of graphical content, preferences must first be input to the management module 12. If no preferences are input, then default preferences may be used. Typically, one preference is to have the blade server 5 with the most graphical content set the pattern. One reason to have the blade server 5 with the most graphical content set the pattern is to insure that enough space is reserved on the displays 3 for all the graphical content. For the illustrative example in FIG. 2, the blade server 5 in slot 1 sets the pattern. The graphical content used for the power indicator graphical content 20 for slot one is selected (along with the location and the color) as the power indication graphical content to use in the displays 3 in each of the three slots. The result is that all power indicator graphical content is now the “#” symbol, located in the upper left comer of the displays 3, and blue in color.

Continuing with the other functions, the blade server 5 in slot one does not have a power button on the display 3 but the blade servers 5 in slots two and three do. Typically, the management module 12 may look to the next most used function and graphical content used in the blade chassis 10. For the teachings herein, the management module 12 selects the smaller “%” symbol to represent all the power buttons. The location and color (yellow) are the same as the power button graphical content 23 for slot two.

Addressing the other functions, only the blade server 5 in slot one has an activity indicator, the activity graphical content 21 for slot one and a warning indicator, the warning graphical content 22 for slot one. The management module 12 selects the activity graphical content 21 for slot one to represent activity in FIG. 3. The color (red) is the same but the location has been moved to the upper right part of display 3. The upper right location is chosen so as not to use the same location (lower left) that is used in the display 3 in the other slots.

Lastly, the management module 12 selects the warning graphical content 22 for slot one to represent the warning indicator. The symbol, symbol size, color (yellow), and location all remain the same because there is no interference with any of the other graphical content in the displays 3.

FIG. 4 depicts an exemplary method 40 for implementing the consistent displays of the graphical content on the displays 3. A first step 41 calls for inputting preferences. A second step 42 calls for polling the BMCs 4 in the blade servers 5. Polling may include determining the version and current display pattern for each BMC 4. A third step 43 calls for formulating consistent displays of graphical content using the preferences and polling information. The third step 43 typically includes addressing every display of graphical content with respect to the preferences inputted in the first step 41. Typically, the management module 12 will implement the consistent displays on the displays 3 via the BMCs 4.

Many options exist for the preferences. For example, one preference may be to impose the “$” symbol with a green color in the upper left part of the displays 3 for all the power buttons. Another preference may be to use custom graphics for the symbols. For another example, the management module 12 will poll all the BMCs 4 to determine the latest version. The management module 12 will use the latest version BMC 4 as a template for mapping the graphical content display pattern for all displays 3. Preferences may include a combination of the above examples.

The management module 12 typically provides for inputting user preferences. The preferences may be inputted manually via at least one of the ICVM 9 and the console 15. The preferences may also be input automatically via the network 13.

While the teachings herein cannot physically move push buttons, the teachings call for mapping the functions of push buttons where possible. For example, the KVM 9 and the media tray 11 may have push buttons that are possible to map. The push buttons may be mapped to a consistent pattern. For example, all top push buttons, where the push buttons may be aligned vertically, may be mapped to perform the same function.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine-readable media comprising machine-readable instructions for providing a central server having a plurality of displays with consistent displays of graphical content, the instructions for implementing a method comprising:
inputting preferences;
polling baseboard management controllers; and
formulating the consistent displays of graphical content to provide the consistent displays of graphical content.

2. The computer program product as in claim 1, further comprising manually inputting preferences.

3. The computer program product as in claim 1, further comprising automatically inputting preferences.

4. The computer program product as in claim 1, further comprising inputting default preferences.

5. The computer program product as in claim 1, further comprising inputting preferences based upon a selected version of the baseboard management controllers.

6. The computer program product as in claim 1, further comprising inputting preferences that impose one display of graphical content for each instance of a function.

7. The computer program product as in claim 1, further comprising inputting preferences that use custom graphics for symbols.

8. The computer program product as in claim 1, further comprising implementing the consistent displays via the baseboard management controllers.

9. The computer program product as in claim 1, further comprising mapping functions of push buttons.

10. The computer program product as in claim 1, wherein the machine-readable media comprises one of an optical media, a compact disc, a magnetic media, a floppy disc, a flash drive, and a network.

11. The computer program product as in claim 1, wherein the product is an add-in.

12. A central server system having a plurality of displays comprising a computer program product having instructions for providing consistent displays of graphical content, the product comprising instructions for:
inputting preferences;
inputting the preferences manually;
inputting the preferences automatically;
inputting default preferences;
inputting the preferences based upon a selected version of the baseboard management controller;
inputting preferences that impose the same graphical content for the same functions;
inputting preferences that use custom graphics for symbols;
mapping functions of push buttons;
polling baseboard management controllers;
formulating the consistent display of graphical content; and
implementing the consistent display of graphical content via the baseboard management controllers.
